(19) United States
(12) Patent Application Publication
(10) Pub. No.: US 2016/0275992 A1
(43) Pub. Date: Sep. 22, 2016

(54) INFORMATION PROCESSING APPARATUS, INFORMATION PROCESSING METHOD, AND NON-TRANSITORY COMPUTER READABLE STORAGE MEDIUM

(71) Applicant: YAHOO JAPAN CORPORATION, Tokyo (JP)

(72) Inventors: Masaya SAKAI, Tokyo (JP); Masaki NOGUCHI, Tokyo (JP); Naoaki YAMASHITA, Tokyo (JP); Yasuaki HASHIMOTO, Tokyo (JP); Shingo HOSHINO, Tokyo (JP); Ryusuke ETCHU, Tokyo (JP); Shigenori KAMATA, Tokyo (JP); Mikiko HIRANO, Tokyo (JP)

(73) Assignee: YAHOO JAPAN CORPORATION, Tokyo (JP)

(21) Appl. No.: 15/040,916

(22) Filed: Feb. 10, 2016

(30) Foreign Application Priority Data
Mar. 20, 2015 (JP) 2015-057943

(51) Int. Cl. G11B 27/34; G06Q 30/02; H04N 21/81; G11B 27/30; H04N 21/234

(52) U.S. Cl. CPC G11B 27/34; G11B 27/309; H04N 21/23418; H04N 21/812; G06Q 30/0277

(57) ABSTRACT

An information processing apparatus according to an embodiment includes an extraction unit, an analysis unit, and a display processing unit. The extraction unit detects switching between scenes in a video content and extracts images of the respective scenes from the video content. The analysis unit analyzes temporal transition of acoustic information contained in the video content. The display processing unit displays a list of the images of the respective scenes extracted by the extraction unit and an image indicating the temporal transition of acoustic information analyzed by the analysis unit on a display unit.

### CROSS-REFERENCE TO RELATED APPLICATION

The present application claims priority to and incorporates by reference the entire contents of Japanese Patent Application No. 2015-057943 filed in Japan on Mar. 20, 2015.

### BACKGROUND OF THE INVENTION

1. Field of the Invention

The present invention relates to an information processing apparatus, an information processing method, and a non-transitory computer readable storage medium.

2. Description of the Related Art

In recent years, along with significant popularization of a network such as the Internet, advertisement distribution is being actively executed through the network. For executing such advertisement distribution, for example, an advertisement distributor receives submission of an advertisement to be placed on a web page or the like from an advertiser, and examines whether or not such an advertisement is appropriate for distribution thereof.

For an examination technique, for example, a technique has been known that analyzes contents of a web page for placing an advertisement and determines presence or absence of violation in light of violation information of preliminarily registered inappropriate texts and images and the like (see, for example, Japanese Patent Application Laid-open No. 2002-189925).

However, the above-mentioned conventional technique is to merely confirm whether or not a web page for placing an advertisement is appropriate, and does not reduce an examination load in a case where determination is provided as to whether a submitted advertisement, per se, is appropriate.

In particular, video advertisements are rapidly spreading along with speeding up and capacity increase of a network in recent years, so that an examination load for such video advertisements is increased. Such a problem is a common problem that also applies to a viewing cost in a case where a general video content is viewed, as well as a case where a video advertisement is examined.

### SUMMARY OF THE INVENTION

An information processing apparatus according to an embodiment includes an extraction unit, an analysis unit, and a display processing unit. The extraction unit detects switching between scenes in a video content and extracts images of the respective scenes from the video content. The analysis unit analyzes temporal transition of acoustic information contained in the video content. The display processing unit displays a list of the images of the respective scenes extracted by the extraction unit and an image indicating the temporal transition of acoustic information analyzed by the analysis unit on a display unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram illustrating an advertisement examination system and an examination support process according to an embodiment.

FIG. 2 is a block diagram illustrating an example of a configuration of an information processing apparatus according to the embodiment.

FIG. 3A is a diagram (part 1) illustrating an example of a configuration of a display layout.

FIG. 3B is a diagram (part 2) illustrating the example of a configuration of a display layout.

FIG. 4 is a diagram illustrating an example of frame division information.

FIG. 5 is a flowchart illustrating steps of an examination support process to be executed by the information processing apparatus according to the embodiment.

FIG. 6 is a hardware configuration diagram illustrating an example of a computer for realizing functions of the information processing apparatus.

### DETAILED DESCRIPTION OF THE PREFERRED EMBODIMENT

Hereinafter, an embodiment of an information processing apparatus, an information processing method, and a non-transitory computer readable storage medium according to the present application will be described in detail, with reference to the drawings. An information processing apparatus, an information processing method, and a non-transitory computer readable storage medium according to the present application is not limited to this embodiment.

Hereinafter, a case where an information processing apparatus is included in an advertisement examination system for examining a video advertisement and such an information processing apparatus executes, as information processing, an examination support process for providing a display in such a manner that it is possible to efficiently examine examination video as an examination object will be described as an example.

1. Advertisement Examination System and Examination Support Process

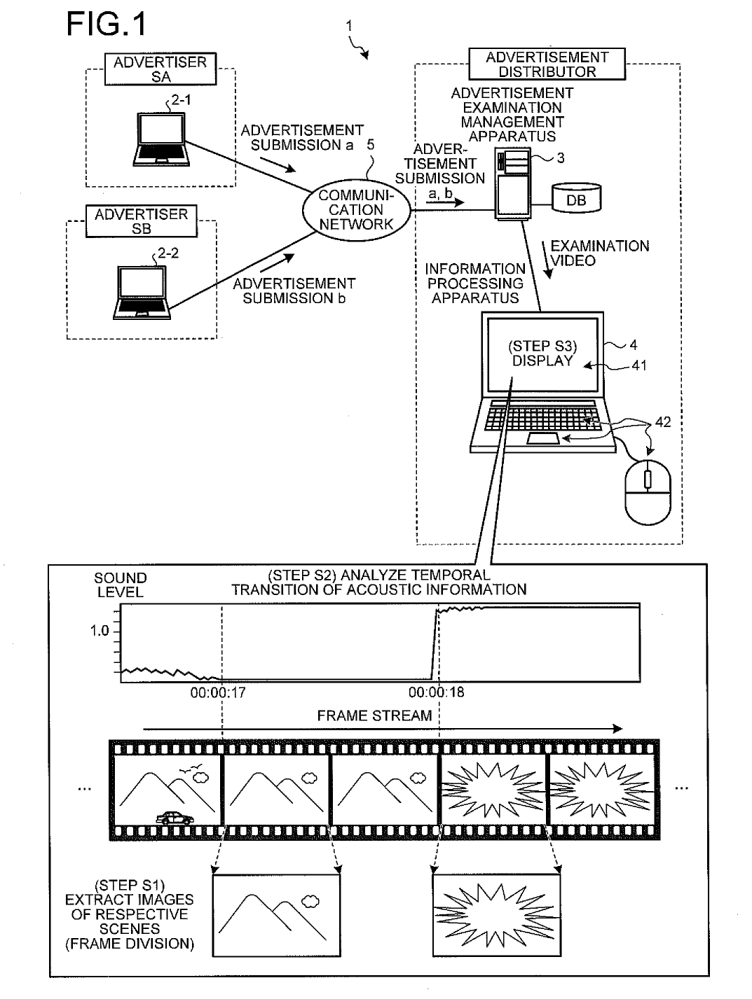

First, an advertisement examination system and an examination support process according to the embodiment will be described. FIG. 1 is a diagram illustrating an advertisement examination system and an examination support process according to the embodiment.

1.1 Advertisement Examination System

As illustrated in FIG. 1, an advertisement examination system 1 includes advertiser terminals 2-1 and 2-2, an advertisement examination management apparatus 3, and an information processing apparatus 4. The advertiser terminals 2-1 and 2-2 (that may collectively be referred to as advertisement terminals 2 below) are managed and operated by advertisers SA and SB (that may collectively be referred to as advertisers S below), respectively. The advertisement examination management apparatus 3 and the information processing apparatus 4 are managed and operated by an advertisement distributor.

The advertiser terminals 2 and the advertisement examination management apparatus 3 are communicably connected to each other through a communication network 5. The communication network 5 is, for example, a Wide Area Network (WAN) such as the Internet. The advertisement examination management apparatus 3 and the information processing apparatus 4 are communicably connected to each other through a Local Area Network (LAN) that is an in-house infrastructure of the advertisement distributor.

The information processing apparatus 4, the advertiser terminals 2 and the advertisement examination management apparatus 3 may communicably be connected to one another through the communication network 5. A communication method of each of the advertiser terminals 2, the advertisement examination management apparatus 3, and the information processing apparatus 4 may be wire communication or may be wireless communication. Although the two advertisers SA and SB are provided as examples in the example illustrated in FIG. 1, the number of advertisers S may be one or may be three or more.

The advertisers S are business operators that request the advertisement distributor to place advertisements, and produce, and submit to the advertisement distributor, advertisement information including, for example, a video advertisement. For example, FIG. 1 illustrates a case where advertisement submission a and advertisement submission b are executed by the advertiser SA and the advertiser SB, respectively.

The advertisement examination management apparatus 3 is informed of the advertisement submissions a and b through the communication network 5. The advertisement examination management apparatus 3 receives the advertisement submissions a and b and registers submitted advertisement information in a database (that will be denoted as a “DB” below).

Herein, in a case where the submitted advertisement information includes a video advertisement, the advertisement examination management apparatus 3 also registers such a video advertisement in the DB as examination video. The advertisement examination management apparatus 3 transmits, to the information processing apparatus 4, the examination video subjected to a request of acquisition by the information processing apparatus 4.

1.2 Information Processing Apparatus

The information processing apparatus 4 includes a display unit 41 and an operation unit 42. The display unit 41 is, for example, a display device such as a display, and the operation unit 42 is, for example, an input device such as a mouse, a keyboard, or a touch-pad.

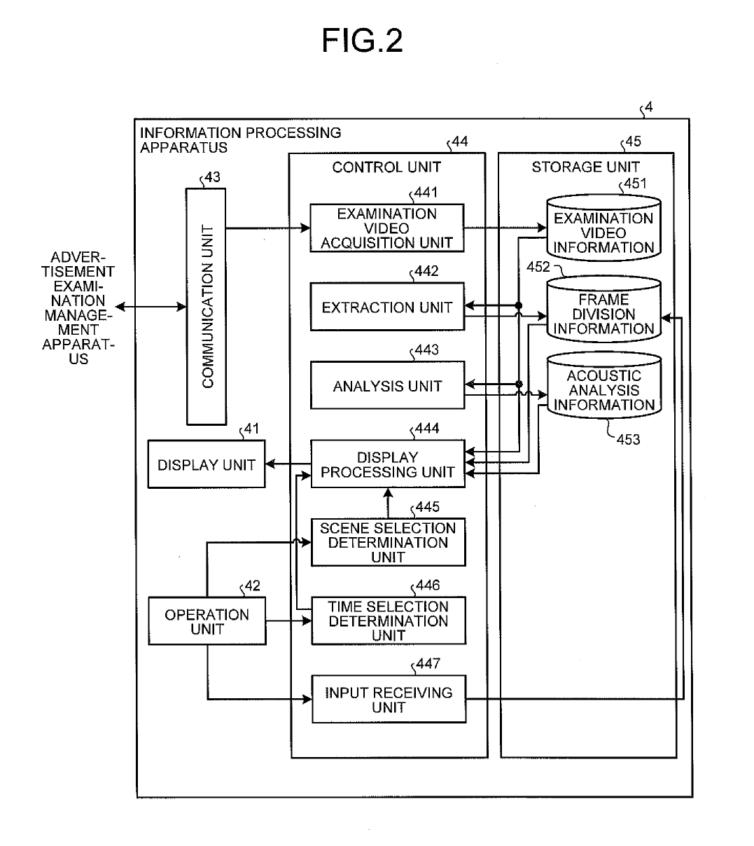

The information processing apparatus 4 also includes a control unit 44 (see FIG. 2 and the subsequent drawings). The control unit 44 executes an examination support process as information processing based on examination video acquired from the advertisement examination management apparatus 3.

1.3 Examination Support Process

A summary of such an examination support process will be described. First, the control unit 44 of the information processing apparatus 4 detects switching between scenes in examination video, and extracts images of the respective scenes corresponding to positions of such switching (step S1). Hereinafter, such extraction of images of the respective scenes may be described as a “frame division”. The control unit 44 detects the switching between scenes based on, for example, an amount of a change between frames in the examination video.

The control unit 44 analyzes temporal transition of acoustic information contained in the examination video (step S2). An object for such temporal transition is any characteristic of audio included in acoustic information, and may be, for example, a sound level or a frequency level.

The control unit 44 displays a list of the images of the respective scenes extracted at step S1 and an image indicating the temporal transition of acoustic information analyzed at step S2 (for example, a sound level waveform illustrated in FIG. 1) on the display unit 41 (step S3). Thereby, for example, an examiner can readily understand an outline of the examination video due to the list of the images of the respective scenes. For example, an examiner can readily visually confirm whether or not an inappropriate scene is present. That is, it is possible to execute examination work for a video advertisement efficiently and an examination cost can be reduced.

The examiner can readily confirm which reproduction time position of the examination video a sound level has a peak at, whether or not the sound level of such a peak is greater than a recommended threshold in an examination, and how long such a peak is retained, based on, for example, an sound level waveform.

That is, it is possible for an examiner to prepare against a rapid increase of a sound volume, so that the examiner can be protected. Confirmation of a sound level greater than a recommended threshold of an examination standard, or the like, can readily be executed, so that it is possible to execute examination work efficiently and an examination cost can be reduced.

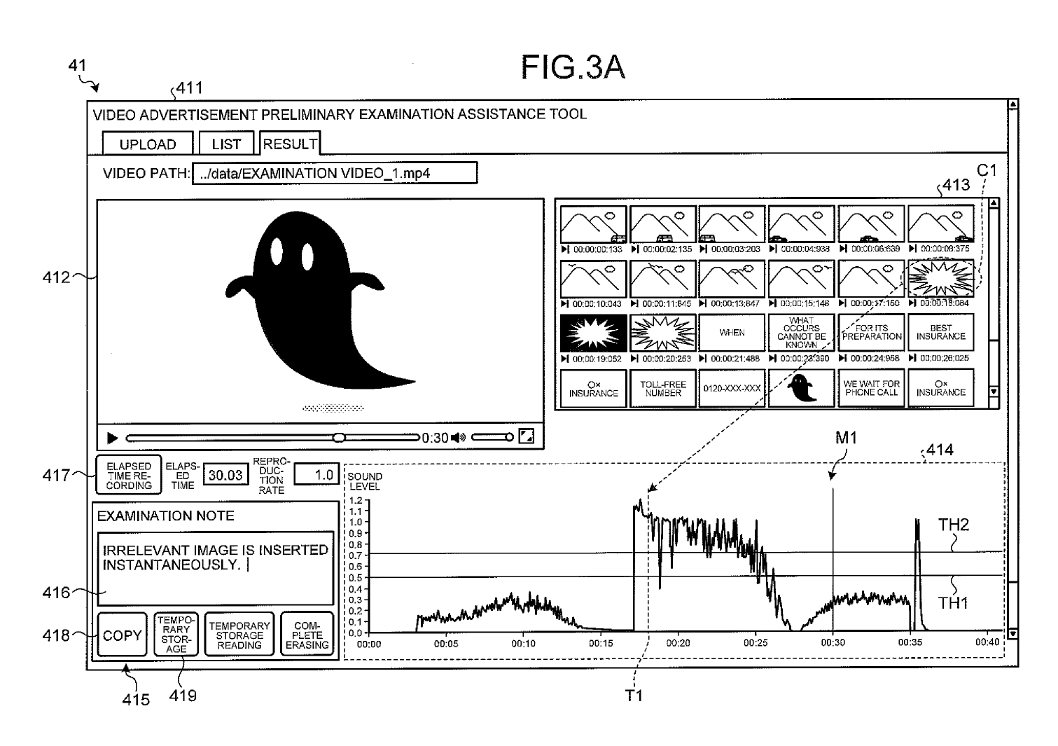

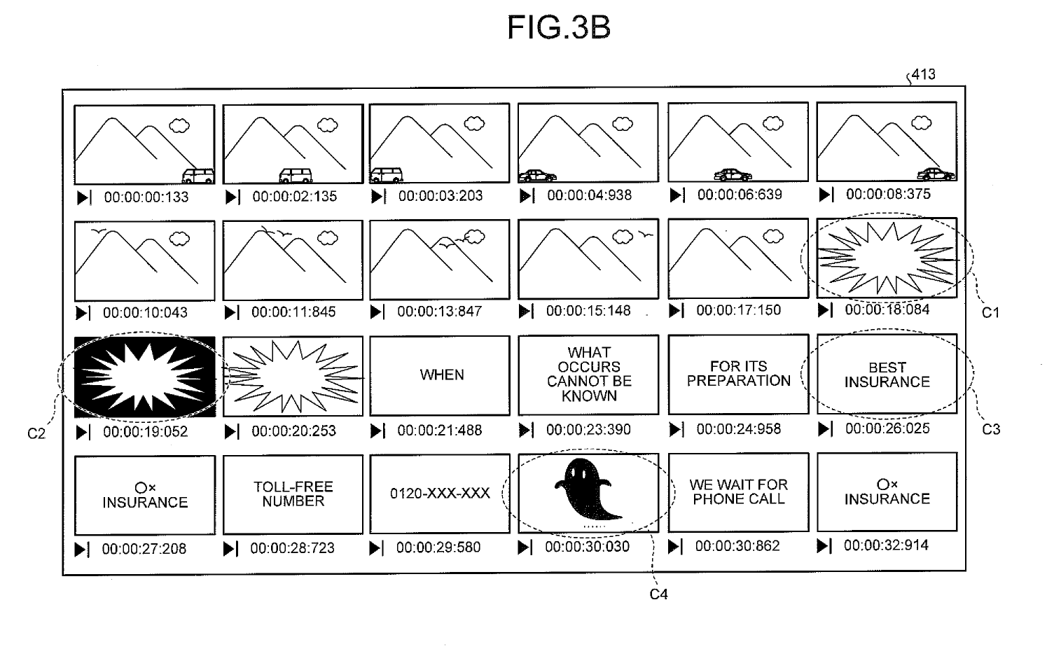

The control unit 44 can display the images of the respective scenes on the display unit 41 in such a manner that the list of the respective images and the image indicating the temporal transition of acoustic information are operated simultaneously. In a case where the operation unit 42 receives a predetermined operation for the respective images displayed on the display unit 41 from an examiner, the control unit 44 executes each function for supporting an examination corresponding to such an operation. The details of this matter will be described later by using FIG. 3A and the like.

The control unit 44 can display the respective images described above on the display unit 41 and execute an examination note function. The examination note function is a function for providing an operation component that can be used in a case where it is desired that a note is recorded in an examination process, and for example, can cause an examiner to record a reproduction time position where a scene is recognized as inappropriate as a result of an examination.

Thereby, for example, it is possible for an examiner to inform the advertiser S of an inappropriate scene in examination video accurately. That is, it is possible to contribute to efficient examination work of a video advertisement and an examination cost can be reduced. Such an examination note function will also be described later by using FIG. 3A and the like.

Thus, in the examination support process of the information processing apparatus 4 according to the embodiment, switching between scenes in examination video is detected to extract images of the respective scenes, temporal transition of acoustic information contained in the examination video is analyzed, and a list of the extracted images of the respective scenes and an image indicating the temporal transition of acoustic information are displayed on the display unit 41.

Therefore, the information processing apparatus 4 according to the present embodiment can reduce an examination cost of a video advertisement. Hereinafter, the information processing apparatus 4 according to the embodiment will be described in more detail by using FIG. 2 and the subsequent drawings.

2. Configuration of Information Processing Apparatus

Next, a configuration of the information processing apparatus 4 will described specifically. FIG. 2 is a block diagram illustrating an example of a configuration of the information processing apparatus 4 according to the embodiment.

FIG. 2 illustrates only components necessary to explain the information processing apparatus 4 and omits illustration of general components. Descriptions of the components having already been described may be simplified or omitted.

As illustrated in FIG. 2, the information processing apparatus 4 includes the display unit 41, the operation unit 42, a communication unit 43, the control unit 44, and a storage unit 45.

The storage unit 45 is realized by, for example, a semiconductor memory element such as a Random Access Memory (RAM) or a Flash Memory, or a storage device such as a hard disk or an optical disk, and stores examination video information 451, frame division information 452, and acoustic analysis information 453 in the example of FIG. 2.

The display unit 41 and the operation unit 42 have already been described, and hence, their descriptions will be omitted herein. The communication unit 43 is, for example, an interface such as a Network Interface Card (NIC). The control unit 44 is capable of transmitting to or receiving from the advertisement examination management apparatus 3, various kinds of information, through the communication unit 43 and the LAN described previously or the like.

The control unit 44 executes overall control of execution of the examination support process described by using FIG. 1. Specifically, the control unit 44 is realized by, for example, a Central Processing Unit (CPU), Micro Processing Unit (MPU), or the like, where various kinds of programs stored in a storage device inside the information processing apparatus 4 are executed while a Random Access Memory (RAM) is a working area. The control unit 44 may be realized by, for example, an integrated circuit such as an Application Specific Integrated Circuit (ASIC) or a Field Programmable Gate Array (FPGA).

As illustrated in FIG. 2, the control unit 44 includes an examination video acquisition unit 441, an extraction unit 442, an analysis unit 443, a display processing unit 444, a scene selection determination unit 445, a time selection determination unit 446, and an input receiving unit 447, and realizes or executes a function or an action of information processing described below. An internal configuration of the control unit 44 is not limited to the configuration illustrated in FIG. 2, and may be another configuration as long as such a configuration can executes information processing described below. Connection relations among respective processing units included in the control unit 44 are not limited to the connection relations illustrated in FIG. 2, and may be other connection relations.

The examination video acquisition unit 441 acquires examination video as an examination object from the advertisement examination management apparatus 3 through the communication unit 43. The examination video acquisition unit 441 stores the acquired examination video in the examination video information 451 in the storage unit 45.

The extraction unit 442 reads the examination video from the examination video information 451, detects switching between scenes therein, and extracts images of the respective scenes corresponding to switching positions of the detected scenes (for example, just after switching between the scenes). The extraction unit 442 detects switching between the scenes based on, for example, an amount of a change between frames. The amount of a change between frames can be obtained based on, for example, an amount of a change in a total of pixel values of pixels for each frame, or the like.

The extraction unit 442 links the extracted images of the respective scenes to corresponding reproduction time positions (that may be described as “time stamps” below) and stores them in the frame division information 452 in the storage unit 45.

The analysis unit 443 analyzes temporal transition of acoustic information contained in the examination video in the examination video information 451. The analysis unit 443 stores a result of analysis in the acoustic analysis information 453 in the storage unit 45. In the acoustic analysis information 453, for example, each reproduction time position of the examination video is linked to a value of a sound level of an acoustic signal at such a position.

The display processing unit 444 executes a process for displaying the examination video, a list of the images of the respective frame-divided scenes, and an image indicating the temporal transition of acoustic information on the display unit 41 based on the examination video information 451, the frame division information 452, and the acoustic analysis information 453.

2.1 Configuration of Display Layout

Herein, an example of a configuration of a display layout displayed on the display unit 41 by the display processing unit 444 will be described by using FIG. 3A and FIG. 3B. FIG. 3A and FIG. 33 are diagrams (part 1) and (part 2) illustrating an example of a configuration of a display layout.

As illustrated in FIG. 3A, the display processing unit 444 displays, for example, a display screen 411 including a title of “VIDEO ADVERTISEMENT PRELIMINARY EXAMINATION ASSISTANCE TOOL” as a screen to be processed in the examination support process, on the display unit 41. The display screen 411 includes, for example, a video reproduction area 412, a list display area 413, an acoustic information display area 414, and an examination note area 415.

The video reproduction area 412 is an area for reproduction of the examination video. The list display area 413 is an area for displaying a list of the images of the respective scenes extracted by the extraction unit 442 and stored in the frame division information 452. Herein, FIG. 3B illustrates enlargement of the list display area 413.

As illustrated in FIG. 3B, a list of the extracted images of the respective scenes is displayed in the list display area 413 in such a manner that, for example, the respective images are arranged from left to right and from top to bottom of the display screen 411 in chronological order. For the displayed images of the respective scenes, corresponding time stamps are displayed in combination.

As an example, FIG. 32 illustrates a case where the examination video is a video advertisement of “ox INSURANCE” wherein sudden explosion scenes (see closed curves C1 and C2) are inserted into tranquil scenes where cars and birds pass sequentially. For the purpose of illustration, closed curves C1 to C4 are illustrated to specify scenes.

A list of the images of the respective scenes of the examination video is displayed in the list display area 413 as illustrated in the example of FIG. 3B, and thereby, it is possible for an examiner to view a so-called “digest” of the examination video, so that the examiner can readily understand an outline of the examination video.

It is possible for an examiner to view such a “digest”, and thereby, a characteristic point to be examined in the examination video can be understood intuitively. For example, the explosion scenes indicated by the closed curves C1 and C2 suddenly appear in the tranquil scenes, and hence, an examiner can readily understand that the scenes in the closed curves C1 and C2 are scenes to be focused in an examination.

Similarly, backgrounds of the scenes indicated by the closed curves C1 and C2 are blinked, and hence, an examiner can intuitively estimate that this instantaneously blinks like a flash and may be an inappropriate advertisement.

It is clear that words of “BEST INSURANCE” are displayed in a larger format in a scene indicated by the closed curve C3, and hence, an examiner can readily estimate that the examination video contains a so-called “highest or greatest level expression” in an advertisement sentence and is an inappropriate advertisement.

An image of a “ghost” that is considered to be irrelevant to an outline of the examination video is suddenly inserted in a scene indicated by the closed curve C4, and hence, an examiner can readily estimate that the examination video may be a subliminal advertisement with an instantaneously inserted irrelevant image.

Thus, the display processing unit 444 displays a list of the images of the respective scenes of the examination video, namely, a “digest”, in the list display area 413, and thereby, it is possible for an examiner to execute examination work efficiently. That is, it is possible to contribute to reduction of an examination cost of a video advertisement.

Next, the acoustic information display area 414 will be described while returning to FIG. 3A. The acoustic information display area 414 is an area for displaying an image indicating the temporal transition of acoustic information analyzed by the analysis unit 443 and stored in the acoustic analysis information 453.

For example, in FIG. 3A, a horizontal axis indicates temporal transition and a vertical axis indicates an example of an image of a sound level waveform as a sound level displayed by the display processing unit 444. The display processing unit 444 can display lines indicating recommended thresholds TH1 and TH2 of the sound level in combination with such an image.

Herein, the temporal transition on the horizontal axis corresponds to the time stamps of the images of the respective scenes in the list display area 413. Thereby, an examiner can readily understand that, for example, sound of the scene of the image indicated by the closed curve C1 is provided near a time position indicated by T1 in the drawing and a sound level is greater than the recommended thresholds TE1 and TH2.

The display processing unit 444 can display a marker M1 for indicating a current reproduction position of the examination video in the video reproduction area 412 in combination, with respect to the temporal transition on the horizontal axis. The display processing unit 444 can move such a marker M1 along a horizontal axis of the sound level waveform, depending on a current reproduction position of the examination video.

Thereby, an examiner can readily understand, for example, a sound level dependent on a reproduction position of the examination video. That is, even if examination video is, for example, to suddenly emit sound with a large sound volume greater than a recommended level, an examiner can prepare against such sound with a large sound volume by preliminarily reducing a volume thereof or the like, so that the examiner can be protected.

In a case where a predetermined operation is received from an examiner through the operation unit 42, the display processing unit 444 can execute each function corresponding to such an operation and display the display screen 411.

For example, in a case where the control unit 44 receives an operation for selecting one image in the list display area 413 from an examiner through the operation unit 42, the display processing unit 444 reproduces the examination video from a scene of such a selected image in the video reproduction area 412.

For example, in a case where the control unit 44 receives an operation for pointing one point in the acoustic information display area 414 from an examiner through the operation unit 42, the display processing unit 444 reproduces the examination video from a reproduction time position on the horizontal axis corresponding to the pointed position in the video reproduction area 412.

Thereby, an examiner can reproduce the examination video from an arbitrary reproduction position indicating a scene to be viewed or a sound level, and hence, examination work can efficiently be executed from, for example, a reproduction position with estimation of an inappropriate scene. That is, an examination cost of a video advertisement can be reduced.

The examination note area 415 is an area that includes an operation component for providing the examination note function described previously, and includes an examination note input box 416. For example, as illustrated in FIG. 3A, reproduction of the examination video is stopped at a reproduction time position of “00:30” indicated by the marker M1 in the acoustic information display area 414 and the subliminal “ghost” image described previously has been displayed in the video reproduction area 412. Herein, “ELAPSED TIME” is accurately “30.03” seconds as illustrated in FIG. 3A.

In such a case, an examiner can input, for example, words desired to be recorded as a note in an examination process such as “IRRELEVANT IMAGE IS INSERTED INSTANTANEOUSLY” to the input box 416. The examination note area 415 further includes an “ELAPSED TIME RECORDING” button 417 as an operation component. An examiner can push the “ELAPSED TIME RECORDING” button 417 on the operation unit 42 to link the “ELAPSED TIME” (herein, “30.03” seconds) to words input into the input box 416.

An examiner pushes, for example, a “COPY” button 418 or a “TEMPORARY STORAGE” button 419 included in the examination note area 415 on the operation unit 42 to store words in the input box 416 in, for example, a temporary storage area included in the information processing apparatus 4 or the like.

Thereby, it is possible to share, for example, a reproduction time position of an inappropriate image in the examination video with a person other than an examiner. Specifically, for example, it is possible to paste a content stored in the temporary storage area into a mail sentence of an electronic mail and send the content to the advertiser S, and hence, the advertiser S can accurately be informed of a position recognized as inappropriate as a result of an examination.

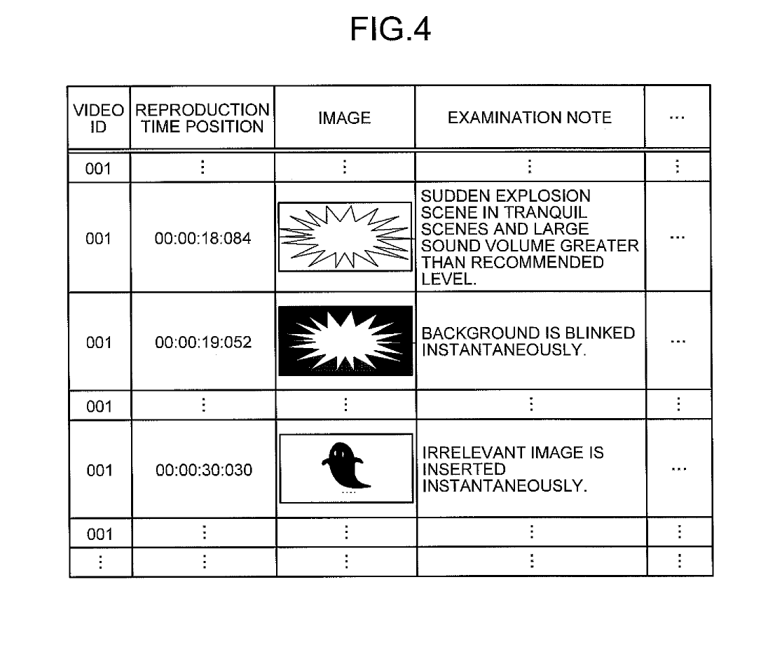

A content of an examination note may be linked to each image included in the frame division information 452 in the storage unit 45. FIG. 4 illustrates an example of such a case. FIG. 4 is a diagram illustrating an example of the frame division information 452. In FIG. 4, a video ID of “001” is assigned to the examination video having ever been described.

As illustrated in FIG. 4, a content of a “EXAMINATION NOTE” may be linked to a “REPRODUCTION TIME POSITION” and an “IMAGE” of each scene. Such linking is executed by the input receiving unit 447 described below. For example, with respect to an image with an explosion scene at a “REPRODUCTION TIME POSITION” of “00:00:18:084” (see the closed curve C1 in FIG. 3B), an examiner inputs an “EXAMINATION NOTE” of “SUDDEN EXPLOSION SCENE FROM TRANQUIL SCENES AND LARGE SOUND VOLUME GREATER THAN RECOMMENDED LEVEL” and this can be linked to the image by the input receiving unit 447.

For example, with respect to an image of an explosion scene at a “REPRODUCTION TIME POSITION” of “00:00:19:052” (see the closed curve C2 in FIG. 3B), an examiner inputs an “EXAMINATION NOTE” of “BACKGROUND IS BLINKED INSTANTANEOUSLY” and this can be linked to the image by the input receiving unit 447.

For example, with respect to an image of a “ghost” scene at a “REPRODUCTION TIME POSITION” of “00:00:30:030” as the example illustrated in FIG. 3A, an examiner inputs an “EXAMINATION NOTE” of “IRRELEVANT IMAGE IS INSERTED INSTANTANEOUSLY” and this can be linked to the image by the input receiving unit 447.

Thus, a content of an examination note is linked to an image and included in the frame division information 452, so that, for example, it is possible to output, and use as a detail of a result of an examination, a content of the example of FIG. 4, and hence, it is possible to contribute to efficient and accurate execution of examination work. That is, an examination cost of a video advertisement can be reduced.

(Continuation of Configuration of Information Processing Apparatus)

Next, the scene selection determination unit 445 will be described while returning to the illustration of FIG. 2. The scene selection determination unit 445 determines whether or not an image of a scene in the list display area 413 displayed on the display unit 41 is selected by an examiner through the operation unit 42. In a case where determination is provided in such a manner that one of images of scenes in the list display area 413 is selected, the scene selection determination unit 445 requests the display processing unit 444 to reproduce the examination video from the selected scene.

In a case where such a request is received, the display processing unit 444 reproduces, and displays on the display unit 41, the examination video from a scene with an image that is determined to be selected by the scene selection determination unit 445.

The time selection determination unit 446 determines whether or not one time position in the temporal transition of acoustic information in the acoustic information display area 414 displayed on the display unit 41 is selected by an examiner through the operation unit 42. In a case where determination is provided in such a manner that one time position in the temporal transition in the acoustic information display area 414 is selected, the time selection determination unit 446 requests the display processing unit 444 to reproduce the examination video from the selected time position.

In a case where such a request is received, the display processing unit 444 reproduces, and displays on the display unit 41, the examination video from a time position that is determined to be selected by the time selection determination unit 446.

In a case where an examiner inputs an examination note into the input box 416 through the operation unit 42 and a predetermined operation such as a push of the “COPY” button 418 or “TEMPORARY STORAGE” button 419 is received, the input receiving unit 447 links to an image of each scene included in the frame division information 452 in the storage unit 45, and stores, for example, a content of the examination note (see FIG. 4).

In a case where an operation other than the predetermined operation having ever been described is received, the input receiving unit 447 causes, for example, the display processing unit 444 to execute each function corresponding to such an operation. For example, in a case where an operation for rotating a mouse wheel of a mouse is received, the display processing unit 444 may be caused to execute a process for changing a reproduction rate of the examination video depending on an amount of rotation of the mouse wheel.

3. Steps of Examination Support Process

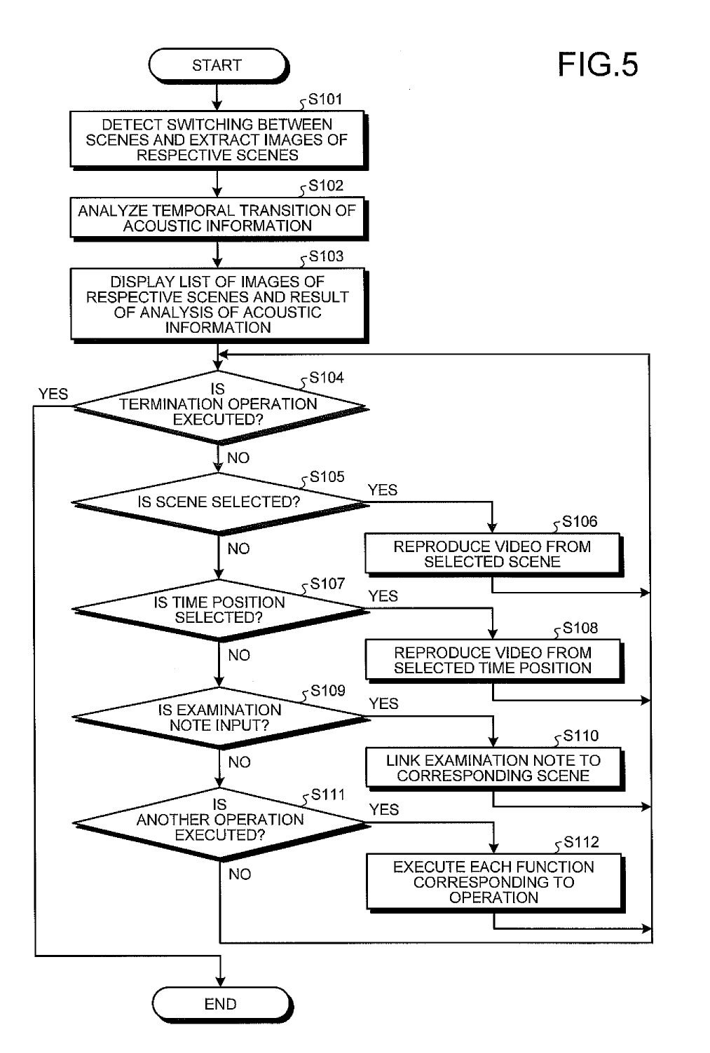

Next, steps of an examination support process will be described as information processing to be executed by the information processing apparatus 4 according to the embodiment. FIG. 5 is a flowchart illustrating steps of an examination support process to be executed by the information processing apparatus 4 according to the embodiment. Herein, in a case where a predetermined termination operation is received from an examiner through the operation unit 42, the control unit 44 of the information processing apparatus 4 terminates the examination support process.

As illustrated in FIG. 5, first, the extraction unit 442 detects switching between scenes from examination video acquired by the examination video acquisition unit 441 and extracts images of the respective scenes (step S101).

Then, the analysis unit 443 analyzes temporal transition of acoustic information contained in the examination video (step S102). One of an extraction process at step S101 and an analysis process at step S102 is not necessarily executed before the other, and for example, both of them may be executed in parallel.

Then, the display processing unit 444 displays a list of the images of the respective scenes and an image indicating a result of analysis of the acoustic information on the display unit 41 (step S103).

Subsequently, for example, the input receiving unit 447 determines whether or not a predetermined termination operation is executed by an examiner (step S104). Herein, in a case where determination is provided in such a manner that a termination operation is not executed (step S104, No), the scene selection determination unit 445 determines whether or not one of the images of the scenes in the list display area 413 is selected (step S105).

Herein, in a case where determination is provided in such a manner that one of the scenes is selected (step S105, Yes), the display processing unit 444 reproduces video from the selected scene (step S106) and the control unit 44 transfers its control to step S104.

On the other hand, in a case where determination condition at step S105 is not satisfied (step S105, No), the time selection determination unit 446 determines whether or not one time position in the temporal transition of acoustic information in the acoustic information display area 414 is selected (step S107).

Herein, in a case where determination is provided in such a manner that one of time positions is selected (step S107, Yes), the display processing unit 444 reproduces video from the selected time position (step S108) and the control unit 44 transfers its control to step S104.

On the other hand, in a case where a determination condition at step S107 is not satisfied (step S107, No), the input receiving unit 447 determines whether or not an examination note input (including a recording operation) is executed (step S109).

Herein, in a case where determination is provided in such a manner that an examination note input is executed (step S109, Yes), the input receiving unit 447 links the examination note to a corresponding scene (step S110) and the control unit 44 transfers its control to step S104.

On the other hand, in a case where a determination condition at step S109 is not satisfied (step S109, No), the input receiving unit 447 determines whether or not another operation is executed (step S111).

Herein, in a case where determination is provided in such a manner that another operation is executed (step S111, Yes), the display processing unit 444 executes each function corresponding to the operation in the display screen 411 (step S112) and the control unit 44 transfers its control to step S104.

On the other hand, in a case where a determination condition at step S111 is not satisfied (step S111, No), the control unit 44 transfers its control to step S104.

In a case where determination is provided in such a manner that a termination operation is executed at step S104 (step S104, Yes), the control unit 44 terminates the examination support process.

4. Hardware Configuration

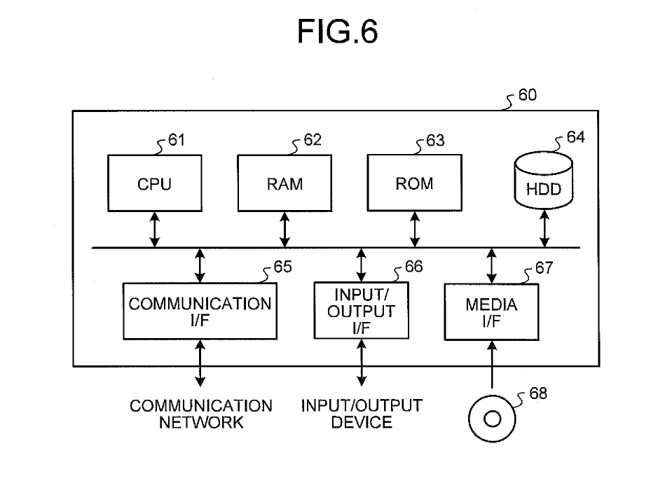

The information processing apparatus 4 according to the embodiment is realized by, for example, a computer 60 with a configuration as illustrated in FIG. 6. FIG. 6 is a hardware configuration diagram illustrating an example of a computer for realizing functions of the information processing apparatus 4. The computer 60 includes a Central Processing unit (CPU) 61, a Random Access Memory (RAM) 62, a Read Only Memory (ROM) 63, a Hard Disk Drive (HDD) 64, a communication interface (I/F) 65, an input/output interface (I/F) 66, and a media interface (I/F) 67.

The CPU 61 operates based on programs stored in the ROM 63 or the HDD 64 and controls each unit. The ROM 63 stores a boot program to be executed by the CPU 61 at a startup of the computer 60, a program dependent on hardware of the computer 60, and the like.

The HDD 64 stores programs to be executed by the CPU 61, data to be used in such programs, and the like. The communication interface 65 corresponds to the communication unit 43, receives, and transmits to the CPU 61, data from another instrument through the communication network 5, and transmits data produced by the CPU 61 to another instrument through the communication network 5.

The CPU 61 controls an output device such as a display or a printer and an input device such as a keyboard or a mouse through the input/output interface 66. The CPU 61 acquires data from the input device through the input/output interface 66. The CPU 61 outputs produced data to the output device though the input/output interface 66.

The media interface 67 reads, and provides to the CPU 61 through the RAM 62, programs and data stored in a recording medium 68. The CPU 61 loads such programs from the recording medium 68 onto the RAM 62 through the media interface 67, and executes the loaded programs. The recording medium 68 is, for example, an optical recording medium such as a Digital Versatile Disc (DVD) or a Phase change rewritable Disk (PD), a magneto-optical recording medium such an a Magneto-Optical disk (MO), a tape medium, a magnetic recording medium, a semiconductor memory, or the like.

In a case where the computer 60 functions as the information processing apparatus 4, the CPU 61 of the computer 60 executes the programs loaded on the RAM 62 to realize a function of each of the examination video acquisition unit 441, the extraction unit 442, the analysis unit 443, the display processing unit 444, the scene selection determination unit 445, the time selection determination unit 446, and the input receiving unit 447. The HDD 64 realizes a function of the storage unit 45 to store the examination video information 451, the frame division information 452, the acoustic analysis information 453, and the like.

Although the CPU 61 of the computer 60 reads from the recording medium 68 and executes these programs, these programs may be obtained from another device through the communication network 5, for another example.

5. Effect

The information processing apparatus 4 of the advertisement examination system 1 according to the embodiment includes the extraction unit 442, the analysis unit 443, and the display processing unit 444. The extraction unit 442 detects switching between scenes in examination video and extracts images of the respective scenes from the examination video. The analysis unit 443 analyzes temporal transition of acoustic information contained in the examination video. The display processing unit 444 displays a list of the images of the respective scenes extracted by the extraction unit 442 and an image indicating the temporal transition of acoustic information analyzed by the analysis unit 443 on the display unit 41.

Thereby, an examiner can readily understand an outline of the examination video due to, for example, the list of the images of the respective scenes. An examiner can readily visually confirm, for example, whether or not an inappropriate scene is present. That is, it is possible to readily understand a position to be focused in an examination and efficiently execute examination work, so that an examination cost can be reduced. An examiner can readily confirm which reproduction time position a sound level of the examination video has a peak at, whether the sound level at that peak is greater than the recommended thresholds TH1 and TH2, and how long that peak is maintained, due to, for example, a sound level waveform. That is, it is possible for an examiner to preliminarily prepare against an event of a rapid sound volume increase so that the examiner can be protected. Confirmation of a sound level greater than the recommended thresholds TH1 and TH2 or the like can readily be executed, and thereby, it is possible to execute examination work efficiently so that an examination cost can be reduced.

The information processing apparatus 4 includes the scene selection determination unit 445. The scene selection determination unit 445 determines whether or not an image of a scene displayed on the display unit 41 is selected. The display processing unit 444 reproduces, and displays on the display unit 41, the examination video from the scene with the image that is determined to be selected by the scene selection determination unit 445.

Thereby, an examiner can reproduce the examination video from an arbitrary scene to be focused in an examination, and hence, it is possible for the examiner to execute examination work efficiently.

The information processing apparatus 4 includes the time selection determination unit 446. The time selection determination unit 446 determines whether or not one time position in the temporal transition of acoustic information displayed on the display unit 41 is selected. The display processing unit 444 reproduces, and displays on the display unit 41, the examination video from one time position that is determined to be selected by the time selection determination unit 446.

Thereby, an examiner can reproduce the examination video from an arbitrary time position to be focused in an examination, and hence, it is possible for the examiner to execute examination work efficiently.

The display processing unit 444 sets, and displays on the display unit 41, information indicating reproduction time positions of the examination video corresponding to the images of the respective scenes on the image indicating the temporal transition of acoustic information.

Thereby, an examiner can associate the images of the respective scenes with the temporal transition of acoustic information to understand a relation between both of them visually and intuitively, and hence, the examiner can readily estimate a position to be focused in an examination or the like so that it is possible to contribute to efficient execution of examination work.

The display processing unit 444 displays the input box 416 for receiving an input from an examiner, in combination with the list of the images of the respective scenes and the image indicating the temporal transition of acoustic information, on the display unit 41.

Thereby, in a case where it is necessary for an examiner to record a note in an examination process, its recording can be executed so as to correspond to the list of the images of the respective scenes and the image indicating the temporal transition of acoustic information, and hence, for example, it is possible to accurately inform the advertiser S of an inappropriate position in the examination video or the like so that it is possible to contribute to efficient execution of examination work.

The analysis unit 443 analyzes temporal transition of at least one of amplitude and a frequency of an acoustic signal contained in the examination video, as the temporal transition of acoustic information.

Thereby, even in a case where an acoustic signal contained in the examination video has a sound level greater than the recommended thresholds TH1 and TH2, an examiner can prepare preliminarily so that the examiner can be protected. Also in a case where the examination video contains an acoustic signal with a frequency providing, for example, unpleasant sound greater than a recommended level, an examiner can similarly prepare preliminarily so that the examiner can be protected. An examiner can preliminarily know a reproduction time position of the examination video containing an acoustic signal greater than the recommended thresholds TH1 and TH2, and hence, it is possible to contribute to efficient execution of examination work by the examiner.

6. Others

Although an aspect of the embodiment of the present application has been described above in detail based on the drawings, this is an illustration and it is possible to implement the present application as the aspect described in a section of the disclosure of the invention as well as other modes with a variety of modifications and improvements applied based on knowledge of those skilled in the art.

For example, although the information processing apparatus 4 described above acquires the examination video from the advertisement examination management apparatus 3, the information processing apparatus 4 may have a configuration capable of acquiring the examination video from an inter-communicably connected Web server or the like through the communication network 5. In such a case, the advertiser S also uploads the examination video as an examination object to this Web server through the communication network 5.

The information processing apparatus 4 described above may be realized by a tablet-type terminal with a touch panel mounted thereon or the like, or realized by calling an external platform or the like by an Application Programming Interface (API), network computing, or the like, depending on a function of the information processing apparatus 4, and thus, the configuration of the information processing apparatus 4 can be changed flexibly.

Although the display processing unit 444 reproduces, and displays on the display unit 41, the examination video from a scene with an image that is determined to be selected by the scene selection determination unit 445, another process can also be executed. For example, the display processing unit 444 can also extract a plurality of images from video contained in a scene with an image that is determined to be selected by the scene selection determination unit 445, and display a list of the plurality of images on the display unit 41. Thereby, an examiner can simply confirm each scene and it is possible to execute examination work efficiently. A process for extracting a plurality of images from video contained in a scene is executed by, for example, the extraction unit 442. The extraction unit 442 uses, for example, a threshold smaller than a threshold of an amount of a change between frames for determining switching between scenes to extract images of frames with an amount of a change from a last frame being greater than the threshold, as images contained in a scene. The extraction unit 442 can also extract N images at reproduction time positions that divide video of a scene into N (wherein N is an integer greater than or equal to 2) as images contained in the scene.

The extraction unit 442 reads examination video from the examination video information 451 and detects switching between scenes based on an amount of a change between frames, where such an amount of a change may be an amount of a change between continuous frames or may be an amount of a change with reference to a first frame of a scene. As the first frame of a scene is a reference, switching between scenes can be detected even in a case where the scenes are switched slowly.

The extraction unit 442 detects an object in the examination video due to image analysis of the examination video, and can detect timing of appearance or disappearance of such an object as timing of switching between scenes.

Although the display processing unit 444 described above displays the image indicating the temporal transition of acoustic information analyzed by the analysis unit 443 on the display unit 41, emphatic display can also be executed at a time position where, for example, an acoustic signal indicates a non-recommended value greater than the recommended thresholds TH1 and TH2 described above. In such a case, an image of a scene corresponding to a time position indicating the non-recommended value described above in the list of the images of the respective scenes in the list display area 413 can also be emphatically displayed.

An aspect of emphatic display may be any aspect as long as it is possible to draw attention of an examiner, where a variety of techniques, for example, blinking of a display, a background color different from those of other portions, surrounding with a bold contour, or a combination thereof, may be used. In a case where such emphatic display is executed, the display processing unit 444 may also emphasize and display a message for calling attention such as “viewing caution” directed to the examiner in combination. For example, in the display layout of FIG. 3A, a message of “VIEWING CAUTION”, “WARNING”, or the like may be blinked and displayed with characters with a large font size at a central portion of the display screen 411 at the right side of a title of “VIDEO ADVERTISEMENT PRELIMINARY EXAMINATION ASSISTANCE TOOL” so as to be noticeable.

Thereby, a function of preliminarily informing that caution or mental preparation is required for viewing can be provided to an examiner as examination work assistance tool.

Although the information processing apparatus 4 described above has been described so as to be positioned as a support apparatus for supporting examination work for a video advertisement in the advertisement examination system 1, the kind of work is not limited to examination work. Therefore, video is also not limited to one for an advertisement, and the information processing apparatus 4 can be applied to a case where any video content is viewed.

According to an aspect of an embodiment, an information processing apparatus, an information processing method, and a non-transitory computer readable storage medium can be provided that can reduce a viewing cost for a video content.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. An information processing apparatus, comprising:
an extraction unit that detects switching between scenes in a video content and extracts images of the respective scenes from the video content;
an analysis unit that analyzes temporal transition of acoustic information contained in the video content; and
a display processing unit that displays a list of the images of the respective scenes extracted by the extraction unit and an image indicating the temporal transition of acoustic information analyzed by the analysis unit on a display unit.

2. The information processing apparatus according to claim 1, further comprising
a scene selection determination unit that determines whether or not an image of a scene among the images of the respective scenes displayed on the display unit is selected, wherein
the display processing unit reproduces, and displays on the display unit, the video content from the scene whose image is determined to be selected by the scene selection determination unit.

3. The information processing apparatus according to claim 1, further comprising
a time selection determination unit that determines whether or not one time position in the temporal transition of acoustic information displayed on the display unit is selected, wherein
the display processing unit reproduces, and displays on the display unit, the video content from the one time position that is determined to be selected by the time selection determination unit.

4. The information processing apparatus according to claim 1, wherein the display processing unit sets, and displays on the display unit, information indicating reproduction time positions of the video content corresponding to the images of the respective scenes on the image indicating the temporal transition of acoustic information.

5. The information processing apparatus according to claim 1, wherein the display processing unit displays an input box that receives an input from a user, in combination with the list of the images of the respective scenes and the image indicating the temporal transition of acoustic information, on the display unit.

6. The information processing apparatus according to claim 1, wherein the display processing unit emphatically displays a time position at which an acoustic signal indicates a non-recommended value, in the image indicating the temporal transition of acoustic information, and emphatically displays an image of a scene corresponding to the time position at which an acoustic signal indicates a non-recommended value, in the list of the images of the respective scenes.

7. The information processing apparatus according to claim 1, wherein the analysis unit analyzes temporal transition of at least one of amplitude and a frequency of an acoustic signal contained in the video content as the temporal transition of acoustic information.

8. An information processing method to be executed by a computer, comprising:
detecting switching between scenes in a video content;
extracting images of the respective scenes from the video content;
analyzing temporal transition of acoustic information contained in the video image;
displaying a list of extracted images of the respective scenes and an image indicating the analyzed temporal transition of acoustic information on a display unit.

9. A non-transitory computer readable storage medium having stored therein an information processing program causing a computer to execute a process comprising:
detecting switching between scenes in a video content;
extracting images of the respective scenes from the video content;
analyzing temporal transition of acoustic information contained in the video image;
displaying a list of the extracted images of the respective scenes and an image indicating the analyzed temporal transition of acoustic information on a display unit.
